(19) United States
(12) Patent Application Publication
(10) Pub. No.: US 2018/0320720 A1
(43) Pub. Date: Nov. 8, 2018

(54) DRIVE ASSEMBLY FOR A VEHICLE ACCESSORY INCLUDING A MULTIPURPOSE COUPLER

(71) Applicant: Magna BOCO GmbH, Wuppertal (DE)

(72) Inventors: Bernardo ERICES, Bergisch Gladbach (DE); Jan HOLBEIN, Köln (DE); Ulrich MAAK, Erkrath (DE)

(21) Appl. No.: 15/967,967

(22) Filed: May 1, 2018

(30) Foreign Application Priority Data
May 2, 2017 (DE) 102017004153.9

(51) Int. Cl. F16B 5/06; F16H 57/025

(52) U.S. Cl. CPC F16B 5/0664; F16H 2057/02082; F16H 57/025

(57) ABSTRACT

In accordance with these and other aspects of the disclosure, a drive assembly for a vehicle accessory is provided. The drive assembly includes a housing for holding a motor for driving the vehicle accessory. At least one coupler is connected to the housing. The coupler is configured to be received by an opening in a panel of the vehicle. The coupler includes at least one lug for engaging an axial underside of the panel. The coupler further includes at least one first locking arm for engaging an axial upper side of a panel of a first thickness for attaching the housing to the panel. The coupler further at least one second locking arm being axially offset from the at least one first locking arm for engaging an axial upper side of a panel of a second thickness for attaching the housing to the panel.

### CROSS-REFERENCE TO RELATED APPLICATIONS

This application claims the benefit of German Patent Application No. DE102017004153.9 filed on May 2, 2017, and titled “DRIVE FIXATION”, the entire disclosure of which is hereby incorporated by reference.

### FIELD

The present disclosure relates generally to a drive assembly for a vehicle accessory. More particularly, the present disclosure relates to a drive assembly for a vehicle accessory, such as a closure device, including a coupler allowing the drive assembly to be attached to vehicle panels of various thicknesses and configurations.

### BACKGROUND

This section provides background information related to the present disclosure which is not necessarily prior art.

Drive assemblies are known in the art for actuating vehicle accessories like closure devices such as door and tailgate locks. Such drive assemblies often include a motor that is coupled with a push-pull cable that extends to the closure device for remotely actuating the closure device. The motor is typically contained within a housing that is attached to a vehicle panel, e.g., a door panel. A known issue with such drive assemblies is that they can produce unwanted noise due to rattling of components of the drive assembly against the panel during the application of external forces like vehicle vibrations. In order to address this issue, it is known to encase components of the drive assembly in foam, or to position a rubber mat between the components and the panel. Furthermore, such drive assemblies are typically attached to the panel by way of screws. Because screws can be time consuming and difficult to install, it is also known to utilize plastic clips for quickly attaching components to the panel. However, an issue with such clips is that they are normally tailored for use with panels of specific thicknesses and configurations.

While current drive assemblies for actuating closure devices meet regulatory requirements and provide enhanced operational convenience, a need still exists to advance the technology and provide alternative arrangements that address and overcome at least some of the known shortcomings.

### SUMMARY

This section provides a general summary of the present disclosure and is not intended to be interpreted as a comprehensive disclosure of its full scope or all of its features, aspects and objectives.

It is an aspect of the present disclosure to provide a drive assembly for a vehicle accessory that is configured to be positioned on various panels having different thicknesses and configurations.

It is a related aspect of the present disclosure to provide a drive assembly for a vehicle accessory that can be quickly and blindly installed to a panel without the use of screws.

In accordance with these and other aspects of the present disclosure, a drive assembly for a vehicle accessory is provided. The drive assembly includes a housing for holding a motor for driving the vehicle accessory. At least one coupler is connected to the housing. The coupler is configured to be received by an opening in a panel of the vehicle. The coupler includes at least one lug for engaging an axial underside of the panel. The coupler further includes at least one first locking arm for engaging an axial upper side of a panel of a first thickness for attaching the housing to the panel. The coupler further at least one second locking arm being axially offset from the at least one first locking arm for engaging an axial upper side of a panel of a second thickness for attaching the housing to the panel.

According to another aspect of the disclosure, another drive assembly for a vehicle accessory is provided. The drive assembly includes a housing for holding a motor and a cable connection for connecting a cable to the motor. At least one clip is connected to the housing and defines a pocket. At least one coupler is removeably received by the pocket of the at least one clip and is configured to be received by an opening in a panel of the vehicle. The coupler includes at least one lug being flexible for engaging an axial underside of the panel. The coupler further includes at least one first locking arm for engaging an axial upper side of a panel of a first thickness for attaching the housing to the panel, and at least one second locking arm being axially offset from the at least one first locking arm for engaging an axial upper side of a panel of a second thickness for attaching the housing to the panel.

### DRAWINGS

The drawings described herein are for illustrative purposes only of selected embodiments and not all implementations, and are not intended to limit the present disclosure to only that actually shown. With this in mind, various features and advantages of example embodiments of the present disclosure will become apparent from the following written description when considered in combination with the appended drawings, in which:

FIG. 1 shows a top view of an example embodiment of a drive assembly connected to a first embodiment of a panel according to an aspect of the disclosure;

FIG. 2 is a partial perspective top view of the drive assembly of FIG. 1;

FIG. 3 is a partial perspective bottom view of the drive assembly of FIG. 1;

FIG. 4 is a perspective view of an example embodiment of a clip base a drive assembly according to an aspect of the disclosure;

FIG. 5 is a perspective view of an example embodiment of a sleeve of a drive assembly according to an aspect of the disclosure;

FIG. 6 is a perspective view of an example embodiment of a cap of a drive assembly according to an aspect of the disclosure;

FIG. 7a is a bottom perspective view of an example embodiment of a ring element of a drive assembly according to an aspect of the disclosure;

FIG. 7b is a top perspective view of the example embodiment of a ring element of FIG. 7a;

FIG. 8 is a partial perspective view of a drive assembly with an exploded view of fastening coupler illustrating the connection of the coupler to the clip;

FIG. 9 is a top view of the first embodiment of a panel including a fastening coupler positioned thereon;

FIG. 10 is a side view of the first embodiment of a panel including a fastening coupler positioned thereon;

FIG. 11 is a bottom view of a second embodiment of a panel including a fastening coupler positioned thereon; and

FIG. 12 is a perspective side view of the second embodiment of a panel including a fastening coupler positioned thereon.

### DETAILED DESCRIPTION

In the following description, details are set forth to provide an understanding of the present disclosure. In some instances, certain circuits, structures and techniques have not been described or shown in detail in order not to obscure the disclosure.

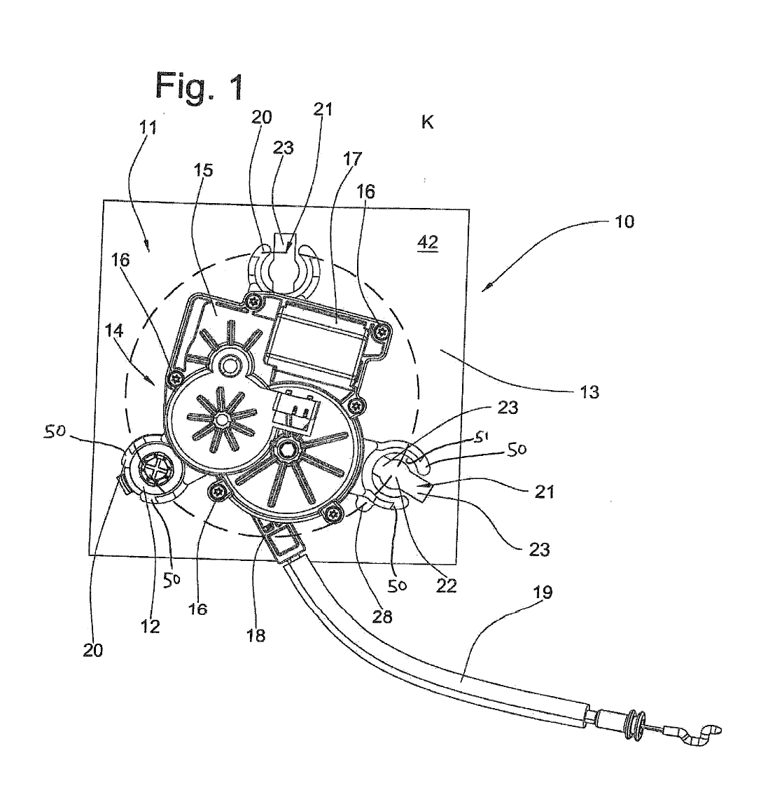

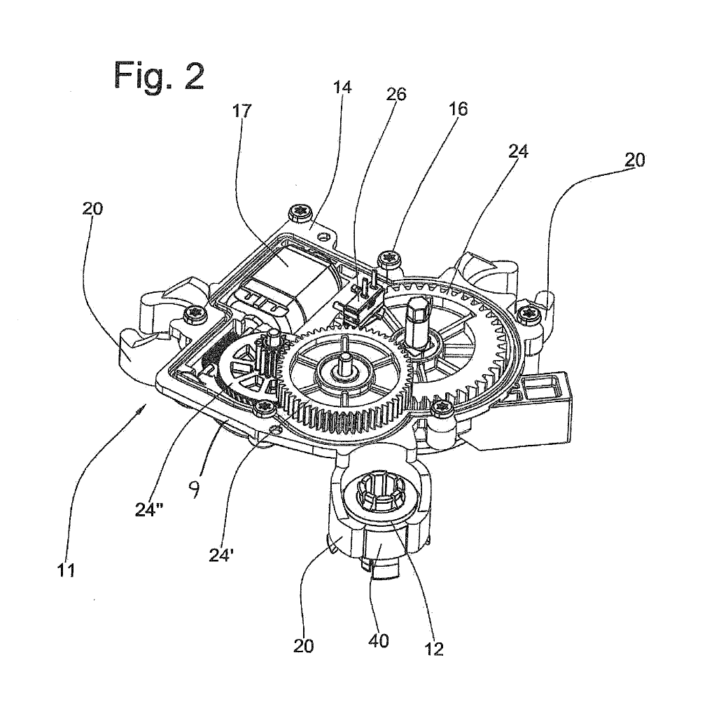

With reference to FIG. 1, a drive assembly 10 for a vehicle accessory is provided. The drive assembly 10 may be used for actuating various vehicle closure devices including, but not limited to door locks, tailgate locks and child safety locks. For example, the drive assembly 10 may be used to actuate a cinch mechanism. The drive assembly includes a drive support 11 which secures a housing 14 to a panel 13, 13′. For example panel 13, 13′ may be a metal sheet panel forming part of a vehicle door assembly, or may be a panel forming part of a door module or door carrier, formed from plastic or the like material, configured to be received within a vehicle door cavity. As best shown in FIG. 2, the housing 14 defines a compartment which contains a motor 17 and associated components for powering the vehicle accessory. A microswitch 26 is further disposed in the housing which may be in electrical connection with the motor 17 and an associated control system for controlling the motor 17. The compartment is defined by a lower portion 9 and a cover 15 which is mounted to the lower portion 9 via screws 16 or other fasteners. A transition area between the lower portion 9 and the cover 15 is sealed to inhibit the entrance of dirt or moisture into the housing 14.

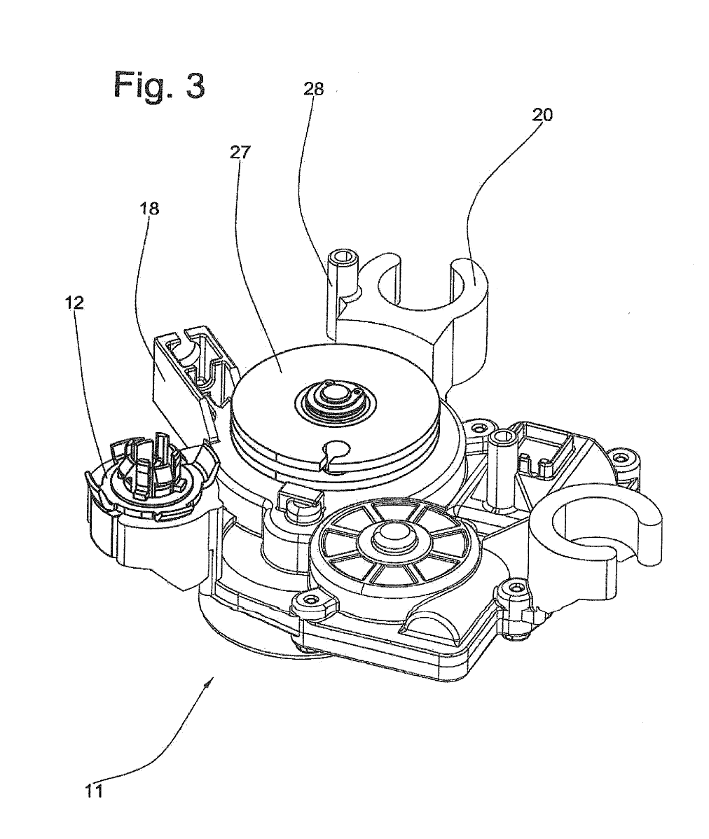

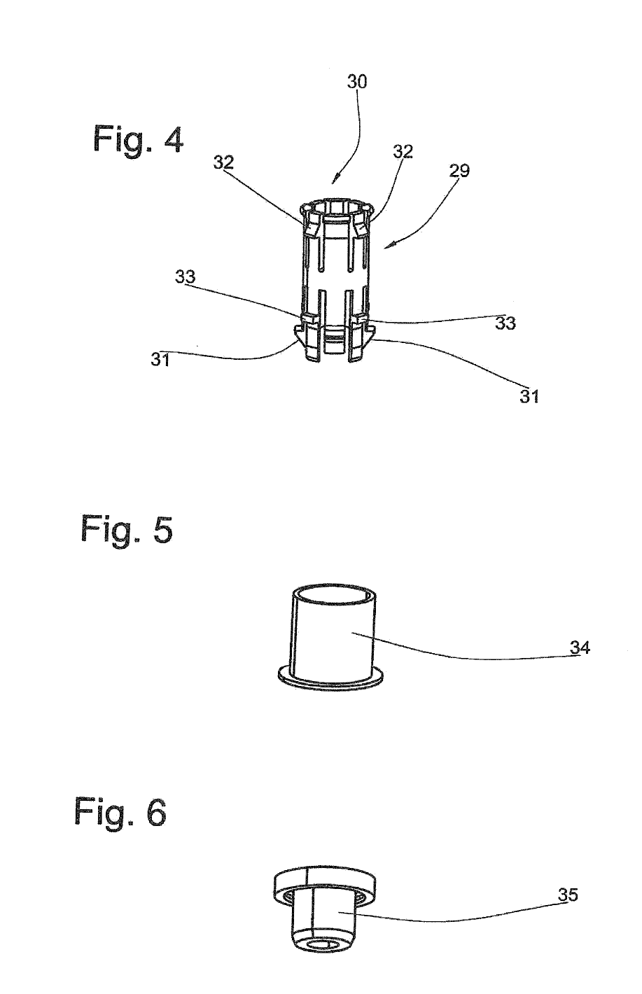

With reference back to FIG. 1, the drive support 11 further includes a cable pull connection 18 for coupling a push-pull cable 19 (embodied as a Bowden cable in the exemplary embodiment) to the motor 17. At its opposite end, the cable 19 may be coupled with the vehicle accessory, for actuating the vehicle accessory. According to this embodiment, three gear wheels 24, 24′ and 24″ are arranged between an output of the motor 17 and the cable connection 18 to provide a gear ratio change therebetween. FIG. 3 illustrates that a cam 27 may be connected to the output of the gears 24, 24′, 24″ prior to the cable connection 18. An end of the push pull cable 19 may be connected to the cam 27 to provide movement of the cable 19 in response to actuation of the motor 17. In other words, the motor 17 is configured to rotate the cam 27 and move the push pull cable 19.

As shown in FIG. 1, the drive support 11 further includes three clips 20 which are attached to the housing 14 for mounting or fixing fastening couplers 12 to the drive support 11 to ultimately secure the drive support 11 to the panel 13, 13′. The clips 20 may be claw-like, each with a pair of legs 50 that terminate adjacent to one another to define a pocket 51 therebetween. It should be appreciated that other numbers of clips 20 could be employed. The clips 20 may be integrally connected to the housing 14 and may be of a hard plastic material that allows for some flexibility to allow the fastening couplers 12 to be secured thereto. As shown in FIG. 1, the clips 20 may be arranged in a circular path K, equidistantly spaced from one another. Due to their uniform spacing, an angular range of approximately 120 degrees is provided between the clips 20. As an alternative, if four clips 20 were utilized an angular range of approximately 90 degrees would be provided between the clips 20.

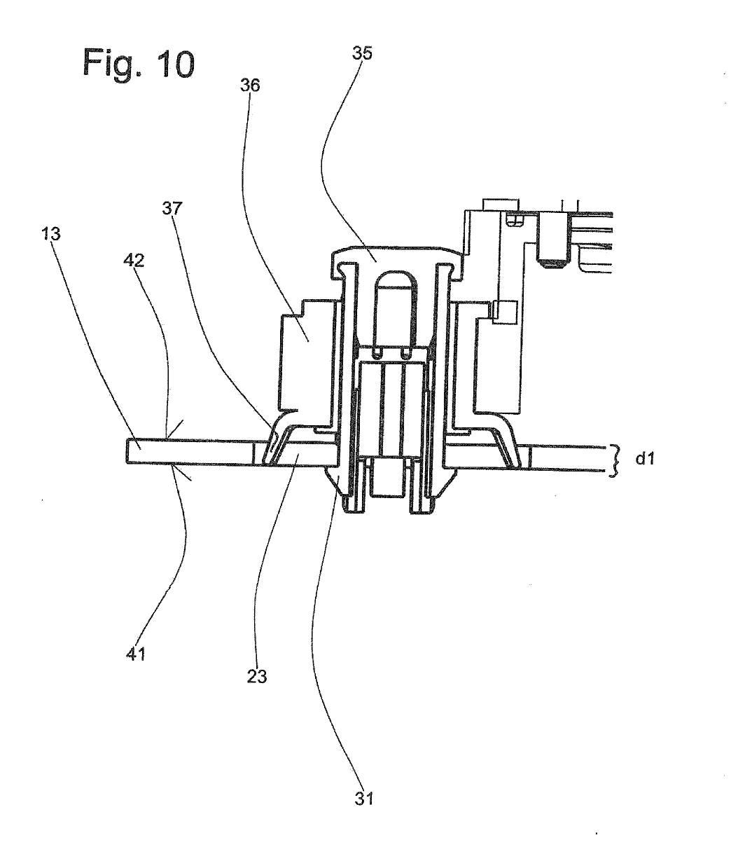

As best shown in FIG. 10, a first embodiment of the panel 13 has a first thickness d1, e.g., between 1.5 and 3 mm. The shape of the panel 13 is shown by way of example in FIG. 1 as essentially square, however the panel 13 could have other shapes and may be a stand-alone panel or part of a larger member of the vehicle. Typically, the panel 13 is a component the vehicle, for example, a region of the door panel. As shown, the panel 13 may be planar at the location of the drive support 11 to form a planar and simple mounting location for the drive bracket 11.

With reference to FIG. 9, the panel 13 defines a plurality of openings 21. Each of the openings 21 is configured to receive a fastening coupler 12. Each of the openings has a circular central region 22, and two block-like wing regions 23 that extend linearly from opposite ends of the central region 22. The purpose of this specific shape of the openings 21 will be explained in greater detail below.

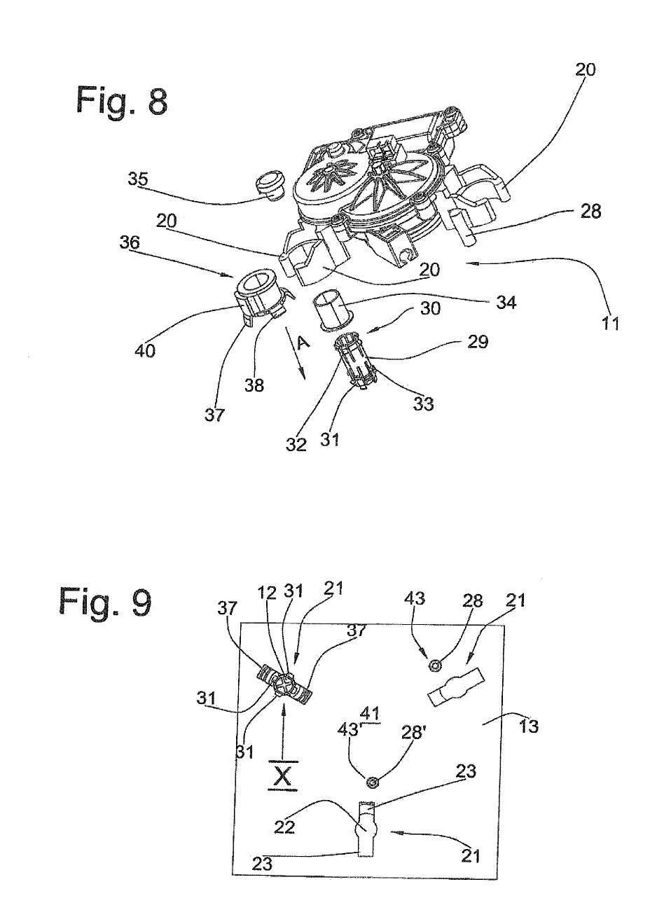

With reference to FIGS. 2 and 8, a plurality of fastening couplers 12 are each removeably connected to one of the clips 20. Each of the fastening couplers 12 includes a coupler base 29. The coupler base 29 is generally tube-shaped and has a top opening 30. A plurality of flexible detent lugs 31 are provided at a lower part of the coupler base 29 for engaging an underside 41 of the panel 13. The coupler base 29 further includes a plurality of upper holders 32 and a plurality of lower holders 33 which flexibly extend radially outwardly from a sidewall of the coupler base 29. The coupler base 29 may be of various materials such as fiber-reinforced glass or polypropylene. A sleeve 34, which is best shown in FIGS. 5 and 8, is positioned about the coupler base 29. The sleeve 34 may be of a metal material and acts as a supporting shell. As best shown in FIGS. 6 and 8, a cap 35 is received by the top opening 30 of the coupler base 29. The cap 35 serves to radially spread the upper holders 32 to prevent later slipping of the coupler base 29 through the clip 20.

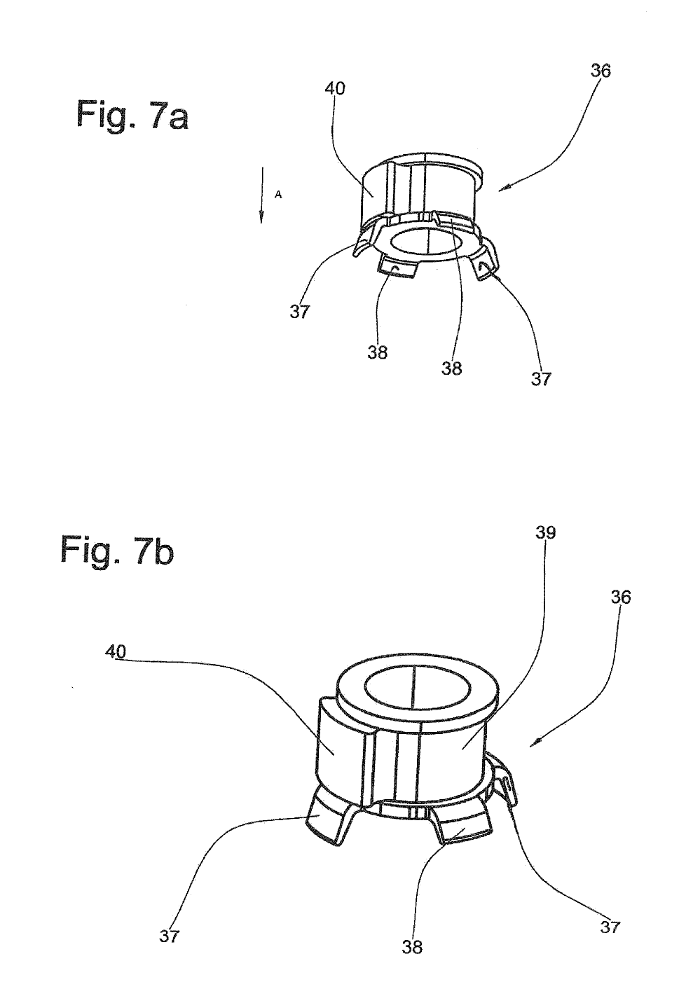

As best shown in FIGS. 7a-7b and 8, an outermost ring element 36 of the fastening coupler 12 is received by each clip 20. The ring element 36 may consist of a plastic, in particular of an EPDM (ethylene propylene diene monomer rubber) material to provide sound dampening properties. As shown in FIGS. 8, 10 and 12, when the fastening coupler 12 is assembled, the ring element 36 surrounds the sleeve 34 and the coupler base 29.

The ring element 36 includes a generally tube shaped body 39 defining a bore and presenting a pair of first locking arm 37 and a pair of second locking arms 38 that each extend from the body 39. The first locking arms 37 are angularly offset from one another by 180 degrees and the second locking arms 38 are radially offset from one another by 180 degrees such that the first and second locking arms 37, 38 alternate about the circumference of the ring element 36. As will be discussed in further detail below, depending on the thickness and arrangement of the panel 13, 13′ the first or second locking arms 37 and 38 are configured to engage an upper side 42 of the panel 13, 13′ while the lugs 31 engage the underside 41 of the panel 13, 13′ to fix the drive support 11 to the panel 13, 13′.

As illustrated in FIGS. 7a-7b, the first locking arms 37 extend a further axial distance from the body 39 of the ring element 36 than the second locking arms 38. The first and second locking arms 37, 38 may also extend at different angles relative to one another. As further shown in FIGS. 7a-7b, an alignment lug 40 extends radially from the body 39 of the ring element 35 for fitting between the legs 50 of the clip 20 as can be seen in FIG. 2, to align the fastening coupler 12 in the clip 20 at a predetermined orientation.

FIG. 8 illustrates fixing of the fastening coupler 12 to the drive support 11. First, the ring element 36 is received by the clip 20 with the legs 50 of the clip 20 biased against the alignment lug 40 for holding the coupler in a predetermined orientation. Second, the metallic sleeve 34 is slid in the axial direction A into the bore of the ring element 36 from below. Next, the coupler base 29 is pushed through the opening 21 in the base 13, 13′, into the sleeve 34 opposite the axial direction A until the upper holders 32 at its upper end override the ring element 36 (and sleeve 34), the lower holders 33 are positioned under the ring element 36, and the lugs 31 engage the underside 41 of the panel 13. It should be appreciated that the upper holders 33 flex radially inwardly during this step to allow the coupler base 29 to be received by the ring element 36. Finally, the cap 35 is inserted into the opening 30 of the coupler base 29 and somewhat against the sleeve 34. It should be appreciated that this assembly procedure is followed for all of the clips 20 of the drive support 11.

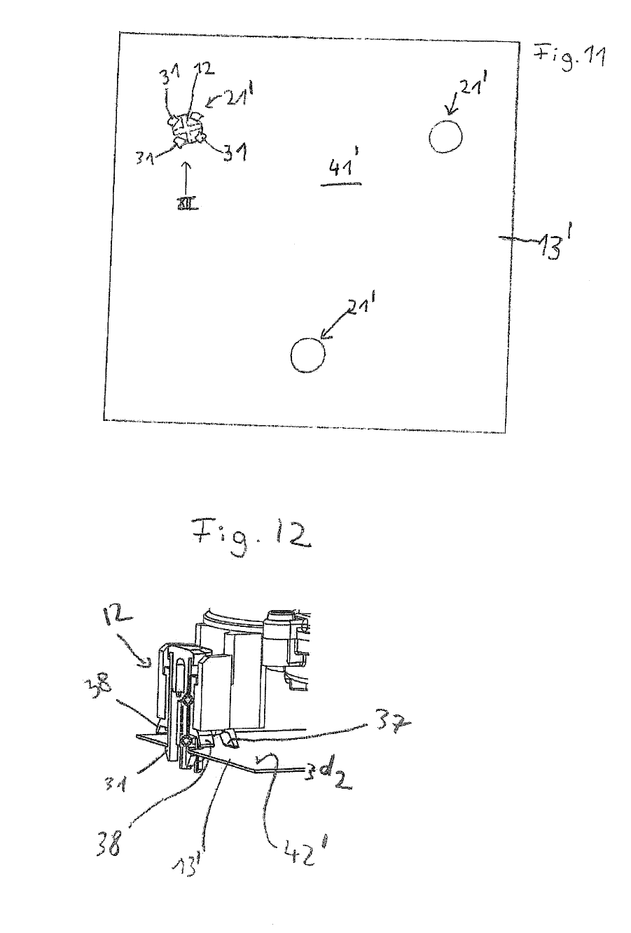

As best illustrated in FIGS. 10 and 12, the drive bracket 11 can be fitted onto a panel 13, 13′ in such a way that the lugs 31 engage the underside 41 of the panel 13, 13′ and either the first locking arms 37 or the second locking arms 38 engage the upper side 42 of the panel 13 to secure the drive support 11 to the panel 13, 13′. Whether the first or second locking arms 37, 38 engage the upper side 42 of the panel 13, 13′ depends on the thickness of the panel 13, 13′ and the arranged of the openings 21. More particularly, as shown in FIGS. 1 and 10, the panel 13 may have a first thickness d1 and may have an opening 21 which includes a central region 22 and two wing regions 23. According to this arrangement, as shown in FIG. 10, the lugs 31 engage the underside 41 of panel 13 while the second locking arms 38 engage the upper side 42 of the panel 14. As further shown, according to this arrangement, the first locking arms 37 extend into the wing regions 23 of the opening 21.

FIG. 11 shows a bottom view of an alternate panel 13′ of a different thickness d2. The second thickness d2 of the second panel 13′ can be, for example, in the range of between 0.7 and 1.5 mm. The openings 21′ according to this embodiment are substantially symmetrical or circular. Any number of such openings 21′ could be provided. Due to the circular shape of the openings 21′ and the thickness of the panel 13′, as shown in FIG. 12, the first locking arms 37 engage the upper side 42′ of the panel 13′ while the lugs 31 engage the underside 41′ of the panel 13′. According to this arrangement, the second locking arms 38 are axially spaced from, and out of contact with the upper side 42′ of the panel 13′. As shown in FIG. 8, the orientation of the ring element 36 in the clip 20 which is dictated by the alignment lug 40 provides for this fixed orientation of the first and second locking arms 37, 38. On the other hand, the base body 29 may be freely moved to any orientation.

As shown in FIG. 9, alignment openings 43 are defined by the panel 13. Further, the drive support 11 includes orientation pins 28 which are received in the alignment opening 43. The alignment openings 43 and orientation pins 28 together provide directional alignment of the drive support 11 relative to the panel 13. It should be appreciated that alignment openings 43 may be provided at other locations of the panel 13 to provide alignment in other orientations.

In view of the foregoing, it should be appreciated that the same coupler 12 may be used to attach the housing 14 to panels 13, 13′ of different thicknesses and shapes. Furthermore, due to the simple arrangement of the coupler 12 and clips 20, the drive support 11 may be connected to the panel 13, 13′ quickly, blindly and without the use of screws.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

What is claimed is:

1. A drive assembly for a vehicle accessory, comprising:
a housing for holding a motor for driving the vehicle accessory;
at least one coupler connected to the housing and configured to be received by an opening in a panel of the vehicle;
the coupler including at least one lug for engaging an axial underside of the panel; and
the coupler further including at least one first locking arm for engaging an axial upper side of a panel of a first thickness for attaching the housing to the panel, and at least one second locking arm being axially offset from the at least one first locking arm for engaging an axial upper side of a panel of a second thickness for attaching the housing to the panel.

2. The drive assembly as set forth in claim 1, wherein the at least one first locking arm is angularly offset from the at least one second locking arms.

3. The drive assembly as set forth in claim 2, wherein the at least one first locking arm includes a pair of first locking arms, wherein the at least one second locking arm includes a pair of second locking arms, and wherein each of the first locking arms are angularly positioned between the pair of second locking arms.

4. The drive assembly as set forth in claim 3, wherein the pair of first locking arms are angularly offset from one another by 180 degrees, and wherein the pair of second locking arms are angularly offset from one another by 180 degrees.

5. The drive assembly as set forth in claim 1, wherein the at least one coupler is of a plastic material.

6. The drive assembly as set forth in claim 1, wherein the at least one clip is connected to the housing and removeably receives the at least one coupler to attach the coupler to the housing.

7. The drive assembly as set forth in claim 6, wherein the at least one clip includes at least three clips being mounted in a common circular path, wherein the at least one coupler includes at least three couplers, and wherein each of the clips removeably receives one of the couplers.

8. The drive assembly as set forth in claim 6, wherein the at least one coupler includes a base body being generally tube shaped and presenting the at least one lug, and wherein the at least one coupler includes a ring element positioned about the base body and received by the at least one clip and presenting the at least one first locking arm and the at least one second locking arm.

9. The drive assembly as set forth in claim 8, wherein a sleeve is positioned between the base body and the ring element.

10. The drive assembly as set forth in claim 9, wherein a cap is received by an axial end of the ring element.

11. The drive assembly as set forth in claim 8, wherein the at least one clip defines a pair of ends terminating adjacent to one another, and wherein the ring element includes an alignment lug protruding radially therefrom and positioned between the pair of ends of the clip for aligning the ring element in a predetermined orientation relative to the clip.

12. The drive assembly as set forth in claim 6 wherein an orientation pin is connected to the housing adjacent to the coupler and extends axially for being received by an alignment opening defined by the panel to provide directional alignment of the housing relative to the panel.

13. A drive assembly for a vehicle accessory, comprising:
a housing for holding a motor and including a cable connection for connecting a cable to the motor for providing movement to the cable;
at least one clip connected to the housing and defining a pocket;
at least one coupler removeably received by the pocket of the at least one clip and configured to be received by an opening in a panel of the vehicle;
the coupler including at least one lug being flexible for engaging an axial underside of the panel; and
the coupler further including at least one first locking arm for engaging an axial upper side of a panel of a first thickness for attaching the housing to the panel, and at least one second locking arm being axially offset from the at least one first locking arm for engaging an axial upper side of a panel of a second thickness for attaching the housing to the panel.

14. The drive assembly as set forth in claim 13, wherein the at least one first locking arm is angularly offset from the second locking arms.

15. The drive assembly as set forth in claim 14, wherein the at least one first locking arm includes a pair of first locking arms, wherein the at least one second locking arm includes a pair of second locking arms, and wherein each of the first locking arms are angularly positioned between the pair of second locking arms.

16. The drive assembly as set forth in claim 15, wherein the pair of first locking arms are angularly offset from one another by 180 degrees, and wherein the pair of second locking arms are angularly offset from one another by 180 degrees.

17. The drive assembly as set forth in claim 13, wherein the coupler is of a plastic material.

18. The drive assembly as set forth in claim 13, wherein the at least one coupler includes a base body being generally tube shaped and presenting the at least one lug, and a ring element positioned about the base body and received by the at least one clip and presenting the at least one first locking arm and the at least one second locking arm.

19. The drive assembly as set forth in claim 18, wherein a sleeve is positioned between the base body and the ring element.

20. The drive assembly as set forth in claim 19, wherein a cap is received by an axial end of the ring element.
